(19) United States
(12) Patent Application Publication
(10) Pub. No.: US 2010/0075601 A1
(43) Pub. Date: Mar. 25, 2010

(54) Wireless Communication Apparatus and Wireless Communication Method

(75) Inventor: Tomokazu Yuasa, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/430,767

(22) Filed: Apr. 27, 2009

(30) Foreign Application Priority Data
Sep. 19, 2008 (JP) 2008-241606

(51) Int. Cl. H04B 7/00

(52) U.S. Cl. 455/41.2

(57) ABSTRACT

According to one embodiment, a wireless communication apparatus includes a communication module configured to wirelessly communicate with an external device, a field strength measurement module configured to measure a field strength which is received by the communication module from the external device, a determination module configured to determine whether a state is a first state in which a period during which the field strength measured by the field strength measurement module is continuously greater than or equal to a threshold is greater than or equal to a certain period, or a second state in that the period is less than the certain period, and a control module configured to execute a first process using the communication module when the state is determined to be the first state, and execute a second process using the communication module when the state is determined to be the second state.

### CROSS-REFERENCE TO RELATED APPLICATIONS

This application is based upon and claims the benefit of priority from Japanese Patent Application No. 2008-241606, filed Sep. 19, 2008, the entire contents of which are incorporated herein by reference.

### BACKGROUND

1. Field

One embodiment of the present invention relates to a wireless communication apparatus and wireless communication method with which it is possible to manipulate a wireless communication device in accordance with a period during which an external device performing wireless communication is detected.

2. Description of the Related Art

In general, a device which executes close proximity wireless transfer includes a wireless smartcard. To perform communication, a wireless smartcard or the like is brought to a position at which it is possible to wirelessly communicate with a target wireless communication device. For example, Jpn. Pat. Appln. KOKAI Publication No. 2005-242976 discloses a technique which executes a preset process when a period during which an IC tag for performing close proximity wireless transfer is held at a certain position (the IC tag is kept close to a position at which it is possible to wirelessly communicate with a target wireless communication device) is greater than or equal to a predetermined period.

In the technique described in Jpn. Pat. Appln. KOKAI Publication No. 2005-242976, however, if the IC tag is held at the certain position for the predetermined period or longer, only one corresponding predetermined process is executed and it is impossible to perform a plurality of operations.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the main components of a computer and wireless smartcard according to an embodiment of the present invention;

FIG. 2 is an exemplary flowchart showing processing for the wireless smartcard of the computer according to the embodiment;

FIG. 3 is an exemplary view schematically showing the processing for the wireless smartcard of the computer according to the embodiment;

FIG. 4 is an exemplary table schematically showing the preset operation setting states of an LED and loudspeaker of the computer according to the embodiment;

FIG. 5 is an exemplary view schematically showing the concept of the operation of the LED in accordance with a change in processing form of the computer according to the embodiment;

FIG. 6 is an exemplary view schematically showing the concept of the operation of the LED in accordance with a change in processing form of the computer according to the embodiment;

FIG. 7 is an exemplary view schematically showing the concept of the operation of the loudspeaker in accordance with a change in processing form of the computer according to the embodiment;

FIG. 8 is an exemplary flowchart showing the processing of the computer according to a modification of the first embodiment;

FIG. 9 is an exemplary flowchart showing the processing of a computer according to the second embodiment; and

FIG. 10 is an exemplary view schematically showing the concept of a selection menu displayed on a display device of the computer according to the second embodiment.

### DETAILED DESCRIPTION

Various embodiments according to the invention will be described hereinafter with reference to the accompanying drawings. In general, according to one embodiment of the invention, a wireless communication apparatus includes: a communication module configured to wirelessly communicate with an external device; a field strength measurement module configured to measure a field strength which is received by the communication module from the external device; a determination module configured to determine whether a state is a first state in which a period during which the field strength measured by the field strength measurement module is continuously greater than or equal to a threshold is greater than or equal to a certain period, or a second state in that the period is less than the certain period; and a control module configured to execute a first process using the communication module when the state is determined to be the first state, and execute a second process using the communication module when the state is determined to be the second state.

Embodiments of the present invention will be described below with reference to the accompanying drawings.

### First Embodiment

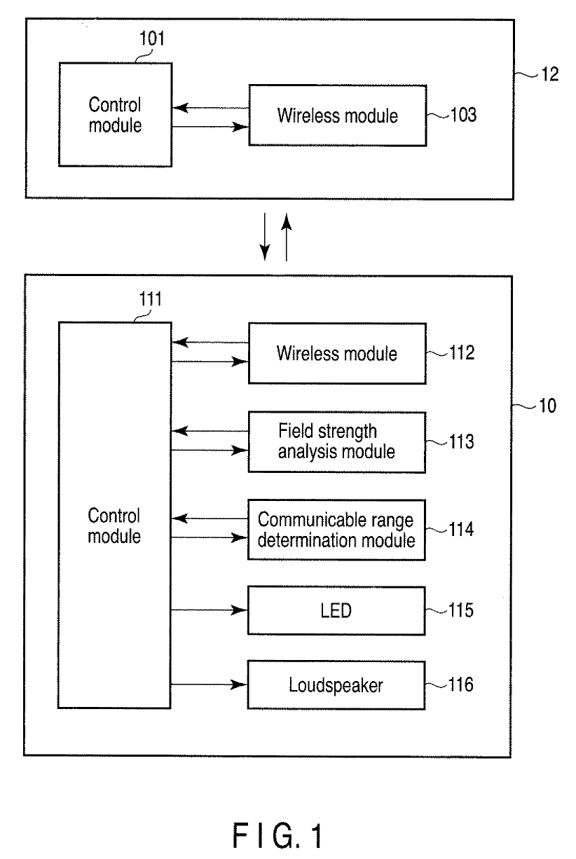

First, the arrangement of a wireless communication apparatus according to the first embodiment of the present invention will be explained with reference to FIG. 1.

This wireless communication apparatus is implemented as, e.g., a computer 10. The computer 10 includes a control module 111, wireless module (communication module) 112, field strength analysis module 113, communicable range determination module (determination module) 114, LED (Light Emitting Diode) (display unit) 115, loudspeaker (audio output module) 116.

When the communicable range determination module 114 determines that the computer 10 is in a first state in which the field strength is greater than or equal to a threshold and it is therefore possible to perform communication, and in which the field strength is continuously detected for a predetermined period or longer, the control module 111 executes a first process (e.g., a process of sending/receiving e-mail). If the module 114 determines that the computer 10 is in a second state in which the field strength is continuously detected for a period less than the predetermined period, the module 111 executes a second process (e.g., a process of starting a Web browser). The wireless module 112 serves as a wireless communication device which performs close proximity wireless transfer with a wireless smartcard (external device) 12. The field strength analysis module 113 measures the field strength in wireless communication executed by a wireless module 103 of the wireless smartcard 12. The communicable range determination module 114 determines based on the field strength measured by the field strength analysis module 113 whether the wireless smartcard 12 is positioned within a communicable range. For example, if the field strength exceeds a predetermined threshold, the module 114 determines that the wireless smartcard 12 is positioned within the communicable range. The LED 115 serves as a display device which displays a change in state such as the above-described first or second state to notify the user of it. The display form of the LED 115 will be explained later. The loudspeaker 116 serves as an audio output device which notifies the user of a change in state such as the above-described first or second state by outputting audio. The audio output form of the loudspeaker 116 will be explained later.

The wireless smartcard 12 includes a control module 101 and the wireless module 103. The control module 101 controls to allow the wireless smartcard 12 to execute close proximity wireless transfer with the computer (wireless communication apparatus) 10. The wireless module 103 serves as a communication device such as an antenna through which the wireless smartcard 12 executes close proximity wireless transfer with the computer 10. Although the wireless smartcard 12 is supplied power from the computer 10 by using a technique such as electromagnetic induction, it may incorporate a battery or the like as needed.

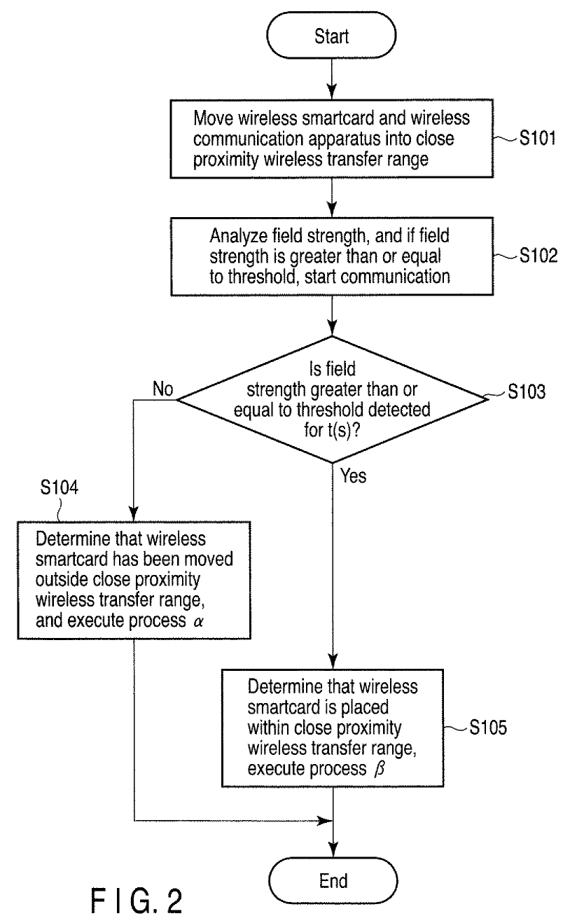

A control method to which the computer serving as the wireless communication apparatus with the above-described arrangement according to the embodiment is applied will be explained with reference to a flowchart shown in FIG. 2.

The wireless smartcard 12 and computer (wireless communication apparatus) 10 are moved into a close proximity wireless transfer range (block S101). For example, if the computer 10 is placed in a predetermined location, the wireless smartcard 12 and computer 10 are moved into a close proximity wireless transfer range by bringing the wireless smartcard 12 close to the computer 10. If the wireless smartcard 12 is placed in a predetermined location, it is possible to move the wireless smartcard 12 and computer 10 into a close proximity wireless transfer range by bringing the computer 10 close to the wireless smartcard 12, as a matter of course.

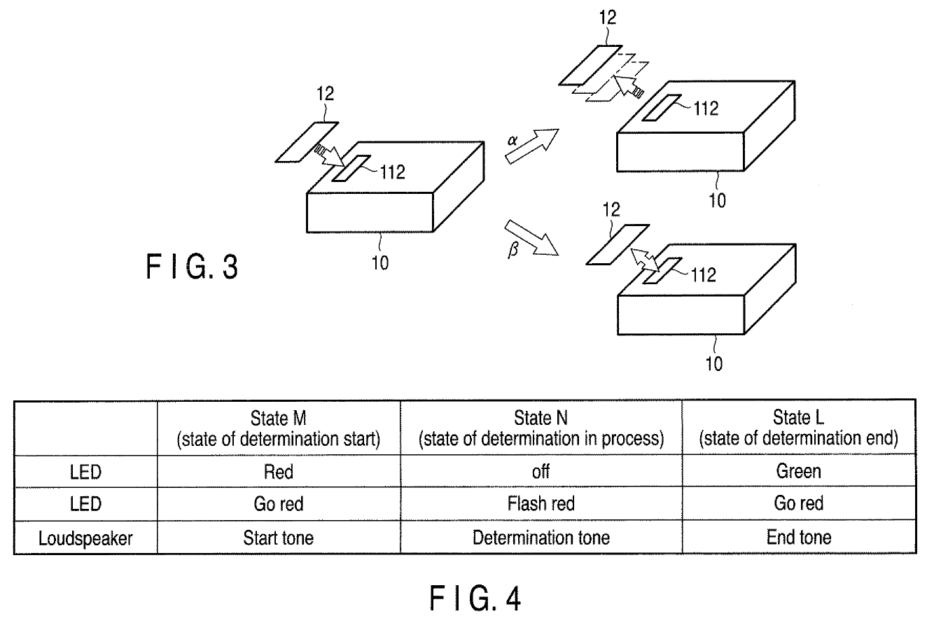

The field strength analysis module 113 of the computer 10 analyzes the field strength with which the wireless module 103 of the wireless smartcard 12 and the wireless module 112 of the computer 10 wirelessly communicate with each other (the module 113 analyzes the field strength sent from the wireless module 103 of the wireless smartcard 12). If the field strength analysis module 113 of the computer 10 determines that the field strength is greater than or equal to the predetermined threshold, the communicable range determination module 114 of the computer 10 determines based on the analyzed field strength that the wireless smartcard 12 is positioned within the communicable range of the computer 10. The wireless module 112 of the computer 10 then starts wireless communication with the wireless module 103 of the wireless smartcard 12 (block S102: a state shown on the left side of FIG. 3).

If the control module 111 of the computer 10 determines that the field strength analysis module 113 of the computer 10 has detected the field strength greater than or equal to the predetermined threshold for a time t(s) greater than or equal to the predetermined threshold, the wireless smartcard 12 is determined to be positioned within a range where close proximity wireless transfer from the computer 10 is possible (operation β) (YES in block S103). A predetermined process (the first process) is performed (block S105: a state shown on the right side of FIG. 3; it corresponds to a case in which a predetermined hardware switch of the computer 10 is pressed for a longer duration). On the other hand, if the control module 111 of the computer 10 determines that the field strength analysis module L13 of the computer 10 has detected the field strength greater than or equal to the predetermined threshold for a time t(s) less than the predetermined threshold, the wireless smartcard 12 is determined to have moved outside the range where close proximity wireless transfer from the computer 10 is possible (operation α) (NO in block S103). A predetermined process (the second process) is then executed (block S104: a state shown on the upper right side of FIG. 3; it corresponds to a case in which a predetermined hardware switch of the computer 10 is pressed for a shorter duration). Note that the threshold of the field strength varies in accordance with standards used in wireless communication or the communication performance of a wireless device, and is therefore set to an appropriate value in advance.

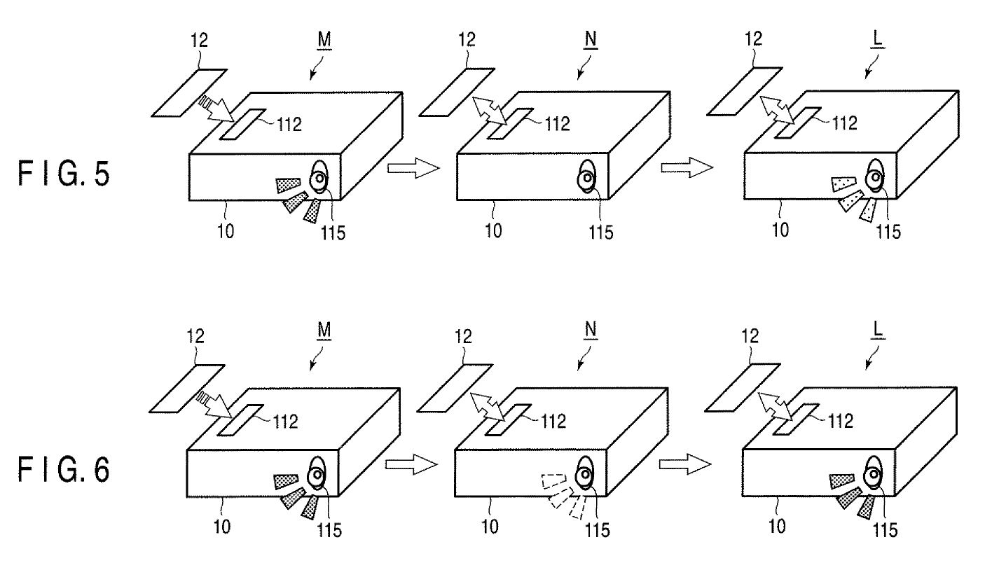

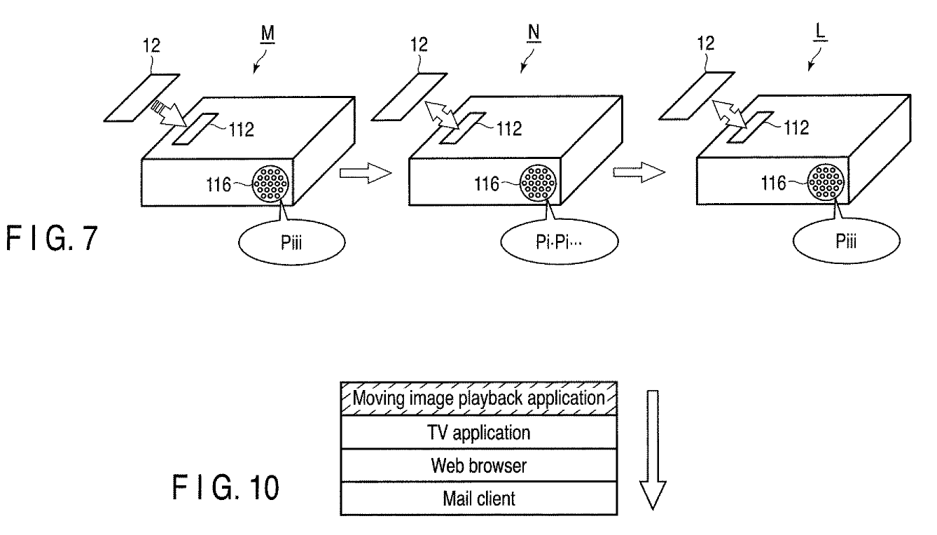

The computer 10 includes the LED 115 and loudspeaker 116. These devices can operate in accordance with the communication state between the computer 10 and the wireless smartcard 12. As shown in FIG. 4, for example, the operations of the LED 115 and loudspeaker 116 are preset in accordance with the communication state between the computer 10 and the wireless smartcard 12, and stored in, e.g., the control module 111 as table data or the like. The communication state between the computer 10 and the wireless smartcard 12 is set to state M, N, or L. Each state is defined as follows, for example. That is, state M is a state in which the computer 10 starts determination of the state of the communication with the wireless smartcard 12 (process start); state N, a state in which the computer 10 is determining the state of the communication with the wireless smartcard 12 (in process); and state L, a state in which the computer 10 has finished the determination of the state of the communication with the wireless smartcard 12 (process end). As shown in FIG. 5, for example, the LED 115 goes red in state M, goes off in state N, and goes green in state L. Alternatively, as shown in FIG. 6, for example, the LED 115 goes red in state M, flashes red in state N, and goes red in state L. As shown in FIG. 7, the loudspeaker 116 outputs a start tone (long beep) in state M, outputs a determination tone (short beep) in state N, and outputs an end tone (long beep) in state L. The above operations of the LED 115 and loudspeaker 116 may be combined. That is, the LED 115 goes on (or flashes) in a preset color, and at the same time, the loudspeaker 116 may output a preset output tone. Furthermore, the LED 115 flashes red in state N, the loudspeaker 116 outputs a preset output tone in state L, and the LED 115 flashes red in state M. In this manner, various combinations can be set. It is also possible to variously set the display color and the flash rate of the LED 115, and the duration of the output tone from the loudspeaker 116. The present invention is not limited to the above LED 115 and loudspeaker 116, and other devices which attract the user's attention (e.g., devices which vibrate) can be used.

According to the above-described first embodiment, it is possible to increase the number of choices of processes which can be performed by close proximity wireless transfer using, e.g., a wireless smartcard. That is, it is possible to execute a preset process in accordance with the period during which a close proximity wireless transfer device using, e.g., a wireless smartcard is detected within a communicable range.

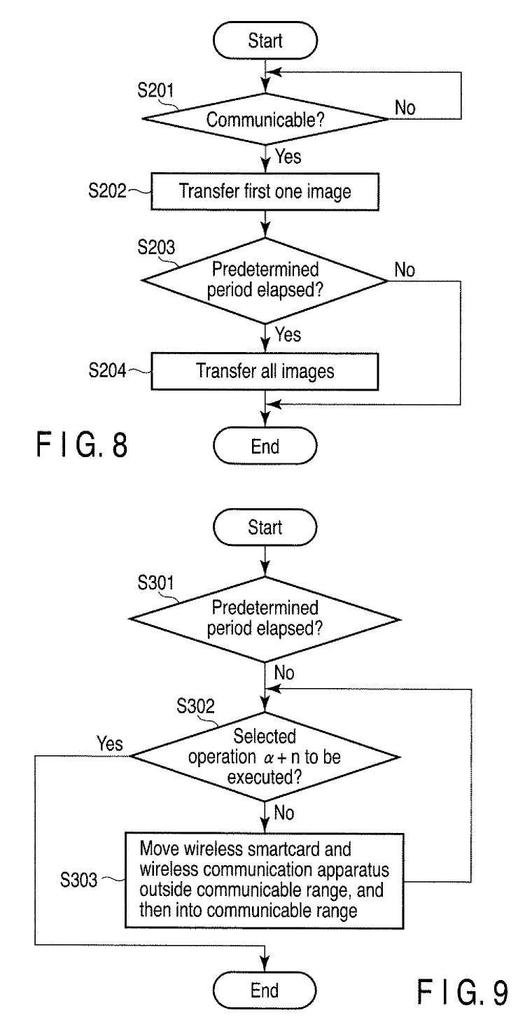

A modification of the first embodiment will be described next with reference to a flowchart shown in FIG. 8.

The field strength analysis module 113 of the computer 10 analyzes the field strength used for wireless communication between the wireless module 103 of the wireless smartcard 12 and the wireless module 112 of the computer 10. If the field strength analysis module 113 of the computer 10 determines that the field strength is greater than or equal to the predetermined threshold, the communicable range determination module 114 of the computer 10 determines based on the analyzed field strength that the wireless smartcard 12 is positioned within the communicable range of the computer 10. The wireless module 112 of the computer 10 then starts wireless communication with the wireless module 103 of the wireless smartcard 12 (YES in block S201). Upon start of wireless communication with the wireless module 103 of the wireless smartcard 12, the control module 111 of the computer 10 transfers the first one image (one file as image data) stored in the wireless smartcard 12 to the computer 10 using close proximity wireless transfer (block S202).

If the control module 111 of the computer 10 determines that the field strength analysis module 113 of the computer 10 detects the field strength greater than or equal to the predetermined threshold for a time t(s) greater than or equal to the predetermined threshold, the wireless smartcard 12 is determined to be placed within a range where close proximity wireless transfer from the computer 10 is possible (YES in block 5203). The wireless smartcard 12 then transfers all image data in itself to the computer 10 using close proximity wireless transfer (block S204).

With the modification of the above first embodiment, it is possible to execute processing at higher speed by starting the processing immediately after close proximity wireless transfer between the wireless smartcard and the computer becomes possible. It is also possible to improve convenience by notifying the user of the processing visually or audibly.

### Second Embodiment

The second embodiment of the present invention will now be explained with reference to FIG. 9.

If a control module 111 of a computer 10 determines that a field strength analysis module 113 of the computer 10 detects the field strength greater than or equal to a predetermined threshold for a time t(s) less than a predetermined threshold (NO in block S301), a wireless smartcard 12 is determined to have moved outside a range where close proximity wireless transfer from the computer 10 is possible (to be referred to as operation α hereinafter) and a selection menu is, for example, displayed on the computer 10. As shown in FIG. 10, For example, this selection menu is a menu for selecting an application which has been registered in the computer 10 in advance. Every time operation α is detected, the selection of the application displayed on the selection menu is switched. When a moving image playback application is selected (see FIG. 10), a selection target is switched by performing operation α. In this case, for example, a TV application is selected. Similarly, every time operation α is detected, a selection target is sequentially switched to a Web application, a mail client, and like. When a desired application is selected on the selection menu (YES in block S302), the desired application selected on the selection menu is started by placing, for a time t(s) greater than or equal to the predetermined threshold, the wireless smartcard 12 within a range where close proximity wireless transfer from the computer 10 is possible (selected operation α+n is performed where operation α+n is, for example, the start operation of the moving image playback application). On the other hand, when a desired application is not selected on the selection menu (NO in block S302), operation α (the wireless smartcard 12 and the computer 10 (wireless communication apparatus) are moved outside a communicable range, and then moved into the range) is done to switch the application selection displayed on the selection menu (block S303).

Note that although the computer 10 displays the above selection menu, a display device may be provided for the wireless smartcard 12 to display the selection menu.

It is possible to obtain the same effect as in the first embodiment by using the above second embodiment.

In a modification of the second embodiment, detecting operation α by the computer 10 is used as a trigger for creating a link with wireless communication (such as a wireless LAN) different from close proximity wireless transfer with the wireless smartcard 12. When the computer 10 detects operation α, another wireless communication such as TransferJet can be executed. In another modification, when the computer 10 detects operation α, the wireless smartcard 12 can send an image to the computer 10. When the computer 10 detects operation β(see FIG. 3), the wireless smartcard 12 can sequentially send images to the computer 10, and the computer 10 can execute a slideshow. Note that the above-described modules can be accomplished as software or hardware.

In the above embodiments, the processes are assigned on assumption that operation α corresponds to a case in which a predetermined hardware switch of the computer 10 is pressed for a shorter duration, and that operation β corresponds to a case in which a predetermined hardware switch of the computer 10 is pressed for a longer duration. Processes assigned to operations α and β are not limited to them.

It is possible to accomplish the procedure of the control processing of the embodiments by software. It is therefore possible to readily obtain the same effect as in the embodiments only by installing a program for executing the procedure into a computer having an optical disk drive through a computer-readable storage medium. A module can be accomplished in software and hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

What is claimed is:

1. A wireless communication apparatus comprising:
a communication module configured to wirelessly communicate with an external device;
a field strength measurement module configured to measure a field strength which is received by the communication module from the external device;
a determination module configured to determine whether a state is a first state in which a period during which the field strength measured by the field strength measurement module is continuously greater than or equal to a threshold is greater than or equal to a certain period, or a second state in that the period is less than the certain period; and
a control module configured to execute a first process using the communication module when the state is determined to be the first state, and execute a second process using the communication module when the state is determined to be the second state.

2. The apparatus of claim 1, further comprising a display unit,
the display unit executing a preset display when the determination module starts determination of a state.

3. The apparatus of claim 2, wherein the display unit executes a preset display when the determination module is determining the state.

4. The apparatus of claim 2, wherein the display unit executes a preset display when the determination module determines that the state is the first state.

5. The apparatus of claim 4, wherein the display unit executes a preset display when the state is determined to have transited from the first state to the second state.

6. The apparatus of claim 1, further comprising a notification module,
the notification module notifying that the determination module has started determination of a state.

7. The apparatus of claim 6, wherein the notification module notifies that the determination module is determining the state.

8. The apparatus of claim 6, wherein the notification module notifies that the determination module has determined that the state is the first state.

9. The apparatus of claim 6, wherein the notification module notifies that the state has transited from the first state to the second state.

10. A wireless communication method used in a wireless communication apparatus which includes a communication module used for wireless communication with an external device, comprising:
measuring a field strength which is received by the communication module from the external device;
determining whether a state is a first state in that a period during which the measured field strength is continuously greater than or equal to a threshold is greater than or equal to a certain period, or a second state in that the period is less than the certain period;
executing a first process when the state is determined to be the first state, and executing a second process when the state is determined to be the second state.
